(19) United States
(12) Patent Application Publication
(10) Pub. No.: US 2011/0261887 A1
(43) Pub. Date: Oct. 27, 2011

(54) METHODS AND DEVICES FOR ESTIMATING MOTION IN A PLURALITY OF FRAMES

(76) Inventors: Wei Siong Lee, Singapore (SG); Yih Han Tan, Singapore (SG); Jo Yew Tham, Singapore (SG); Kwong Huang Goh, Singapore (SG); Dajun Wu, Singapore (SG)

(21) Appl. No.: 12/996,301

(22) PCT Filed: Jun. 5, 2009
(86) PCT No.: PCT/SG2009/000200

§ 371 Date: Apr. 14, 2011

Related U.S. Application Data
(60) Provisional application No. 61/059,502, filed on Jun. 6, 2008.

(51) Int. Cl. H04N 7/50

(52) U.S. Cl. 375/240.16; 375/E07.125; 375/E07.211

(57) ABSTRACT

In various embodiments, a method for estimating motion in a plurality of frames is provided, the method including determining a first set of motion vectors with respect to a first frame and a second frame, the second frame being in succession with the first frame along a time direction, determining a second set of motion vectors with respect to a predicted frame and the second frame, the predicted frame being in succession with the first frame along the time direction; wherein some motion vectors of the second set of motion vectors are interpolated from motion vectors of the first set of motion vectors; and determining a third set of motion vectors based on the first set of motion vectors and the second set of motion vectors.

### TECHNICAL FIELD

Various embodiments generally relate to methods and devices for estimating motion in a plurality of frames.

### BACKGROUND

Typically, a video sequence contains many redundancies, where successive video frames can contain the same static or moving objects. Motion estimation (ME) may be understood as being a process which attempts to obtain motion vectors that represent the movement of objects between frames. The knowledge of the object motion can be used in motion compensation to achieve compression.

In block-based video coding, the motion vectors are determined by the best match for each macroblock in the current frame with respect to a reference frame. A best match for a N×N macroblock in the current frame can be found by searching exhaustively in the reference frame over a search window of ±R pixels. This amounts to (2R+1)² search points, each requiring 3N² arithmetic operations to compute the sum of absolute differences (SAD) as block distortion criterion. This is very high for software implementation.

Some conventional ME techniques to reduce the number of search points using predefined search patterns and early termination criteria assume unimodal error surface; i.e., matching error increases monotonically away from the position of global minimum.

When content motion is large or complex, the assumption of a unimodal error surface may no longer be valid. Consequently, fast ME methods may produce false matches, thus leading to inferior quality motion-compensated frames that degrade coding performance.

### SUMMARY

In various embodiments, a method for estimating motion in a plurality of frames is provided, the method including determining a first set of motion vectors with respect to a first frame and a second frame, the second frame being in succession with the first frame along a time direction, determining a second set of motion vectors with respect to a predicted frame and the second frame, the predicted frame being in succession with the first frame along the time direction; wherein some motion vectors of the second set of motion vectors are interpolated from motion vectors of the first set of motion vectors; and determining a third set of motion vectors based on the first set of motion vectors and the second set of motion vectors.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various embodiments. In the following description, various embodiments are described with reference to the following drawings, in which:

FIG. 1 shows a hierarchical B-picture structure in accordance with an embodiment;

FIG. 2 shows a block diagram illustrating a motion estimation in accordance with an embodiment; and

FIG. 3 shows a diagram illustrating a motion trajectory of a macroblock across frames in accordance with an embodiment.

FIG. 4 shows a hierarchical B-picture structure in accordance with another embodiment.

### DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

The word “exemplary” is used herein to mean “serving as an example, instance, or illustration”. Any embodiment or design described herein as “exemplary” is not necessarily to be construed as preferred or advantageous over other embodiments or designs.

In an embodiment, a “circuit” may be understood as any kind of a logic implementing entity, which may be hardware, software, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be software being implemented or executed by a processor, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the following, vectors and matrices will be indicated using bold letters as well as underlining interchangeably.

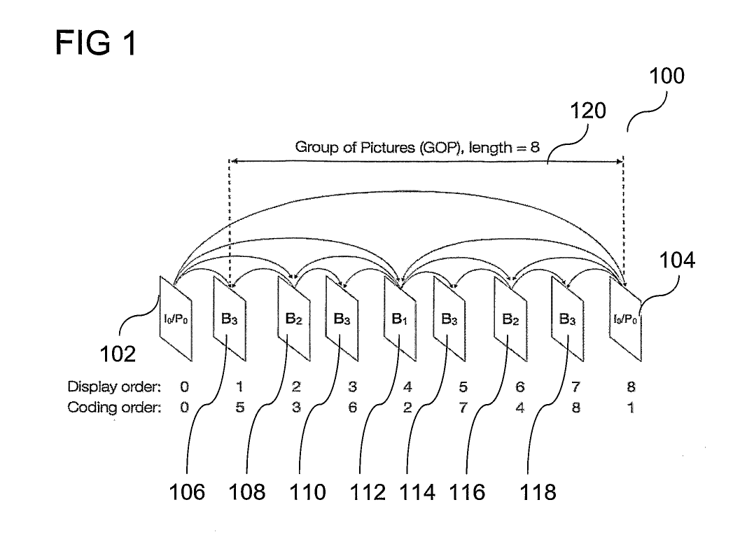

In FIG. 1, frames 106, 108, 110, 112, 114, 116, 118 (e.g. so-called B-pictures) at the lower temporal levels of the hierarchical B-picture (HB) structure 100 are motion estimated from reference frames (e.g. so-called I-pictures or P-pictures) 102, 104 that are temporally further apart. Larger inter-frame motion can be expected at lower temporal levels. The frames may be grouped in so-called Group of Pictures (GOP) 120, which may contain a plurality of e.g. 8, 16, 32, or even more frames (each frame including a plurality of picture elements (pixels) to which coding information such as e.g. luminance and/or chrominance information may be assigned). It is to be noted that a Group of Pictures (GOP) may contain an arbitrary number of frames, which may also vary in a plurality of GOPs in a video sequence, for example. In this implementation, the HB structure 100 may include a plurality of e.g. four temporal levels. Additionally, a GOP may contain intra and inter frames arranged in an arbitrary order for motion estimation. The HB structure is one such example of ordering in the GOP.

As will be described in more detail below, various embodiments provide a framework (which will also be referred to as Lacing in the following) that integrates seamlessly with as such conventional fast ME methods and may improve their motion prediction accuracy when employing the HB structure by e.g. extending their effective motion search range through successive motion vector interpolation along the macroblock's (a macroblock may include one or more blocks, each block including a plurality of pixels) motion trajectories across the frames within the GOP. It has been observed that rigid body motions may produce continuous motion trajectories spanning a number of frames across time. By exploiting these motion characteristics, Lacing may help to progressively guide the motion prediction process while locating the ‘true’ motion vector even across a relatively large temporal distance between the current and reference frames. In this context, it is to be noted that fast ME algorithms, which may be very effective for motion estimation over relatively small motion search ranges, can become ineffective when applied in the HB structure. In various embodiments, fast ME methods may be provided to provide a fast speed and simple motion estimation even with increasing temporal distance.

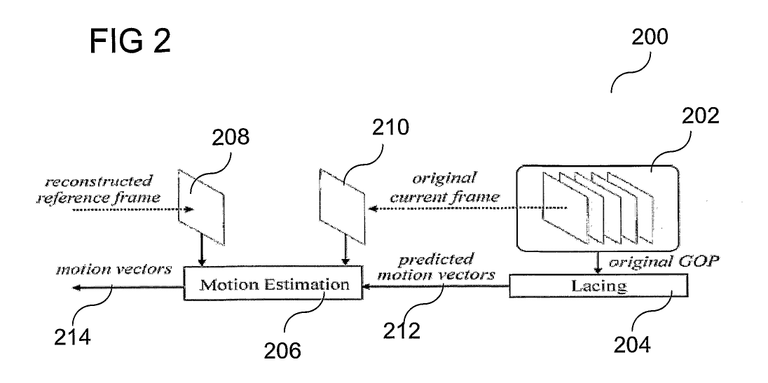

FIG. 2 shows a block diagram 200 illustrating a motion estimation in accordance with an embodiment.

As shown in FIG. 2, an original GOP 202 may be provided to a lacing process 204, which will be described in more detail below. The results of the lacing process 204 (e.g. the determined predicted motion vectors 212 of the lacing process 204) may be provided for motion estimation process 206, which may use at least one reconstructed reference (frame 208) and a frame (also referred to as the original current fame 210, in other words, the original frame which should currently be encoded or on which a motion estimation should be carried out) selected from the GOP 202. In various embodiments, the motion estimation process 206 (which will also be described in more detail below) may provide motion vectors 214, which in turn may be used in a motion compensation process, e.g. in a frame encoding process or frame decoding process, which will not be described in detail herein for reasons of simplicity.

In the following, an implementation of the lacing process 204 will be described in more detail.

Having observed the motion continuity of rigid body motions across frames, the Lacing framework (in other words, the lacing process 204) may exploit these strong temporal correlations in the motion vector fields of neighbouring frames, such that:

M_{t,t-2}(p)≈M_{t,t-1}(p)+M_{t-1,t-2}(p+M_{t,t-1}(p)) (1)

where Mₜ_{₁}_{,t}_{₀} denotes the set of motion vectors of current frame f(t₁) with reference frame f(t₀) and, Mₜ_{₁}_{,t}_{₀}(x,y) represents the motion vector of macroblock positioned at p in the current frame f(t₁). Generally for (t₁−t₀)>1, Mₜ_{₁}_{,t}_{₀}(p) can be approximated by m^{t}^{₁}^{-t}^{₀}⁻¹ using the following iterative equation,

m^{j}=m^{j-1}+Mₜ_{₁}_{-j,t}_{₁}₋ⱼ₋₁,(p+m^{j-1}) (2)

with initial condition

m⁰=Mₜ_{₁}_{,t}_{₁}₋₁(p). (3)

It is noted that the updating term in equation (2) is a motion vector from f(t₁−j) to f(t₁−j−1), which is only across a unit temporal interval. Thus, the updating motion vector can be computed using fast (or small search range) ME methods. This contrasts with the direct computation of Mₜ_{₁}_{,t}_{₀}(p), which would otherwise require the estimation of motion vector over a large search range if t₁−t₀ is large.

In various embodiments, in each iteration of equation (2), the macroblock at p+m^{j-1} is motion estimated. Using the exhaustive method with ±v motion search range, each macroblock may require an average of (t₁−t₀)(2v+1)² search points. For a GOP (e.g. GOP 202) of T frames and with 1+log₂ T temporal levels in the HB structure 100, each macroblock may require an average of (1+log₂ T)(2v+1)² search points.

The following process outlines the steps to reduce the average number of search points to (2v+1)² per macroblock.

For t₀≠t₁, Mₜ_{₁}_{,t}₀(p) is approximated by m^{|t}^{₁}^{-t}^{₀}^{|-1} from the following iterative equations:

m^{j}=m^{j-1}+u(Mₜ_{₁}_{-s·j,t}_{₁}_{-s·(j+1)},pⱼ) (4)

pⱼ=p+m^{j-1} (5)

with s=sgn(t₁−t₀) and the initial condition

m⁰=Mₜ_{₁}_{,t}_{₁}_{-s·1}(p) (6)

The updating vector function u in equation (4) is a motion vector at pj interpolated from the neighboring motion vectors (in various embodiments, bilinear interpolation may be used to obtain u; note that other interpolation methods are applicable, some of which will be described in more detail below):

$${M}_{{t}_{1} - s \cdot j , {t}_{1} - s \cdot ( j + 1 )} ( N ⌊ \frac{{p}_{j}}{N} ⌋ ) , \\ {M}_{{t}_{1} - s \cdot j , {t}_{1} - s \cdot ( j + 1 )} ( N ( ⌊ \frac{{p}_{j}}{N} ⌋ + [ 1 , 0 ] ) ) , \\ {M}_{{t}_{1} - s \cdot j , {t}_{1} - s \cdot ( j + 1 )} ( N ( ⌊ \frac{{p}_{j}}{N} ⌋ + [ 1 , 0 ] ) ) , \\ {M}_{{t}_{1} - s \cdot j , {t}_{1} - s \cdot ( j + 1 )} ( N ( ⌊ \frac{{p}_{j}}{N} ⌋ + [ 1 , 1 ] ) ) \qquad ( 7 )$$

In the following, the process will be summarized in a pseudo code form:

Algorithm 1: Lacing framework for HB structure

Input: f(0), first frame in sequence or last frame

from previous GOP.

| | Input: {f(1), f(2),...,f(T)}, GOP of length T. |
|---|---|
| | Output: \hat{M} , sets of predicted motion vectors |
| 1 | Compute {M_{t,t-1} : 1 ≦ t ≦ T}; |
| 2 | Compute {M_{t,t+1} : 1 ≦ t < T}; |
| 3 | for t ← 1 to T do |

| | |
|---|---|
| 4 | D ← temporal distance of f(t) from its reference; |
| 5 | if D [symbol] 1 then |

| | |
|---|---|
| 6 | foreach Macroblock at p in f(t) do |

| | |
|---|---|
| 7 | \hat{M}_{t,t-D}(p) ← approx. M_{t,t-D}(p) using |
| | equations (4)-(6); |
| 8 | if temporal level of f(t) [symbol] 0 then |

| | |
|---|---|
| 9 | \hat{M}_{t,t+D}(p) ← approx. M_{t,t+D}(p) |
| | using equations (4)-(6); |

| | |
|---|---|
| 10 | end |

| | |
|---|---|
| 11 | end |
| 12 | Refine \hat{M}_{t,t-D}(p) and \hat{M}_{t,t+D}(p) with ME; |

| | |
|---|---|
| 13 | else |

| | |
|---|---|
| 14 | \hat{M}_{t,t-D}(p) ← M_{t,t-1}(p); |
| 15 | \hat{M}_{t,t+D}(p) ← M_{t,t+1}(p); |

| | |
|---|---|
| 16 | end |

| | |
|---|---|
| 17 | end |

Equations (4)-(6) form computing steps in the Lacing framework, which is outlined in Algorithm 1 for motion estimating frames in the HB structure (such as e.g. HB structure 100). Unlike equation (2), no motion estimation may be required when evaluating the updating vector in equation (4), since M_{t,t±1} can be precalculated (see step 1 to 2 in Algorithm 1). In various embodiments, only M_{t,t±1} may be accessed at fixed macroblock positions.

In the following, a complexity analysis will be provided on the above-described lacing process.

When motion estimation is used with Lacing, the computation overheads are attributed to the following processes:
ME is performed during the pre-caculation stage in step 1-2 and the refinement of the predicted motion vectors in step 12 of Algorithm 1. Depending on the actual ME strategy used, Lacing can introduce up to an additional 2 times the number of search points per macroblock. This is acceptable since fast ME techniques already have very low average search points to begin with.
Interpolating the motion vectors in equation (4) requires only a relatively small computation. In the bilinear interpolation case, 2×(12MULS+6ADDS) (MULS: Multplications; ADDS: Additions) is provided for each macroblock. This is insignificant, compared to N² ABS+(2 N²−1)ADDS (ABS: Absolute value) required to compute the SAD (Sum of absolute differences) of N×N macroblock at each search point.

Using the exhaustive method with a search range of ±v pixels, and applying Lacing to a HB-structured GOP of T frames and 1+log₂ T temporal levels requires an average of (4−3/T)(2v+1)² search points, or 2(2v+1)² search points without the refinement step 12 in Algorithm 1.

Various embodiments provide an application of a hierarchical B-pictures structure in e.g. a H.264/SVC video coding standard and provide a solution to meet the challenge for effective motion estimation (ME) across frames with much larger temporal distance. Various embodiments provide a Lacing framework which may integrate seamlessly with as such conventional fast ME methods to extend their effective search range along the motion trajectories. Experiments showed that Lacing can yield significantly better motion prediction accuracy by as high as 3.11 dB improvement in quality and give smoother motion vector fields that require fewer number of bits for encoding the motion vectors.

In the following, a more concrete implementation of the above described embodiment of the lacing process will be described. It is to be noted, that in the following, a modified notation will be used compared with the lacing process described above.

As already mentioned above, motion estimation (ME) is a mechanism provided in video compression. It is a process of obtaining motion information to predict video frames. The video can be compressed by coding the motion information and prediction error. This method works because similar blocks of pixels can usually be found in neighboring picture frames. The motion information coded may be the displacement between matching pixel blocks, or macroblocks.

This coded data may also be referred to as motion vectors (such as e.g. motion vectors 214). To obtain a matching for a N×N macroblock, an exhaustive search can be performed over ±M pixel range in the preceding picture frame. This requires N²(2M+1)² computations (using minimum sum of absolute differences (SAD) as a matching criteria), which is very high for software implementation.

Examples of fast ME techniques or ME methods that may be used in various embodiments are, inter alia: three-step search, 2D logarithmic search, new three-step search, diamond search (DS) and adaptive rood pattern search (ARPS).

As also already mentioned above, under the HB prediction structure (e.g. HB structure 100), each frame in the GOP (group of pictures) 202 may be bi-directionally estimated from reference pictures at a lower temporal level. At lower temporal levels, the distance (also referred to as temporal distance) between the estimated and reference frames increases. Motion estimation may become more difficult as the temporal distance increases. First, there is likely to be fewer good-matching macroblocks due to occluding and uncovering areas. This may lead to large prediction error and reduces coding efficiency. Secondly, due to longer motion trajectories, a larger search area may be needed to find the matching macroblock. This may significantly increase the computation cost. Hence, when fast ME methods are applied to the HB structure (e.g. HB structure 100), they generally fail to give satisfactory performance because of their limited effective search range.

Various embodiments may improve the prediction accuracy of fast ME algorithms in the HB structure (e.g. HB structure 100). This may be achieved by extending their effective search range through tracing motion trajectories across GOP.

Lacing is algorithmically simple with modest computation overhead. Yet, significant performance gain may be observed with the Lacing framework.

As will be described in more detail below, the Lacing framework may extend the effective search range of existing fast motion estimation methods and may improve their prediction accuracy in the hierarchical B-pictures structure. One idea of various embodiments including Lacing is to trace the motion trajectories of macroblocks across GOP.

The ‘lace’ of macroblocks along each trajectory are likely to have high similarity. The position of macroblocks on each ‘lace’ can be used to determine the motion vector of a macroblock with reference to any picture frame in the same GOP. The rational is that the trajectories of moving objects in a picture sequence are generally coherent and continuous across time.

We begin by illustrating the motion trajectory tracing of macroblocks across GOP.

Let f(t) represent a picture frame at time t. Also, let X(t₁,t₀) denotes the set of motion vectors of f(t₀) with reference frame f(t₁). If t₀>t₁, then X(t₁,t₀) is a set of forward motion vectors. Backward motion vectors if otherwise.

For simplicity, a motion trajectory tracing to determine forward motion vectors will be described in more detail; the adaptation of the process for a motion trajectory tracing to determine backward motion vectors is straightforward.

Consider a GOP of K frames {f(t)}_{0≦t≦K} with key frame f(0), its set of forward motion vectors is denoted

χₚ={X(1,0), X(2,1), . . . , X(K,K−1)}, (8)

which can be obtained using fast ME techniques. Then, the Lacing algorithm estimates the HB forward motion vectors,

$$X ( K , 0 ) , X ( \frac{K}{2} , 0 ) , X ( \frac{K}{4} , 0 ) , X ( \frac{3 K}{4} , \frac{K}{2} ) , \qquad ( 9 )$$

from χₚ by tracing. As an example, X(k,k−2) will be estimated from both X(k,k−1) and X(k−1,k−2).

For each N×N macroblock positioned [m,n] in f(k), its motion vector is denoted as

x(k,k−1;m,n)∈ X(k,k−1). (10)

The referenced macroblock in f(k−1) is positioned at

[m′,n′]=[m,n]+x(k,k−1;m,n). (11)

However, it is likely that x(k−1,k−2;m′,n′) may not be in X(k−1,k−2) since m′ and n′ are not necessarily (cN−1) for some integer c. To continue tracing the trajectory into f(k−2), the motion vector may be interpolated

$$\tilde{x} [ k - 1 , k - 2 ; {m}^{′} , {n}^{′} ] = {b}_{l} ( \frac{{m}^{′} - {m}^{″}}{N} ) A ( k - 1 , {m}^{″} , {n}^{″} ) {b}_{r} ( \frac{{n}^{′} - {n}^{″}}{N} ) \qquad ( 12 )$$

where

bₗ(q)=[1−q,q],

bᵣ(q)=bₗ^{T}(q) [symbol] I₂,

$$[ {m}^{′} , {n}^{′} ] = [ N ⌊ \frac{{m}^{′}}{N} ⌋ , N ⌊ \frac{{n}^{′}}{N} ⌋ ] , \\ and$$

$$A ( t , m , n ) = [ \begin{matrix}x ( t , t - 1 ; m , n ) & x ( t , t - 1 ; m , n + N ) \\ x ( t , t - 1 ; m + N , n ) & x ( t , t - 1 ; m + N , n + N )\end{matrix} ] .$$

Finally, the interpolated motion vector \tilde{x} may be used to compute

\tilde{x}[k,k−2;m,n]=x[k,k−1;m,n]+\tilde{x}[k−1,k−2;m′,n′] (13)

Generally, for 0≦J<K, x(K,J;m,n) can be obtained by iterating the following

$$x [ K , J ; m , n ] = x [ K , K - 1 ; m , n ] + {\sum }_{j = 1}^{K - J - 1} \tilde{x} ( K - j , K - j - 1 ; {m}_{j} , {n}_{j} ) \qquad ( 14 )$$

To obtain the backward motion estimation in the HB structure, the same procedures may be repeated with the set

χ_{b}={X(K−1,K), X(K−2,K−1), . . . , X(1,2)}, (15)

and iterating for L>K,

$$x [ K , J ; m , n ] = x [ K , K + 1 ; m , n ] + {\sum }_{j = 1}^{K - J - 1} \tilde{x} ( K + j , K + j + 1 ; {m}_{j} , {n}_{j} ) \qquad ( 16 )$$

The following summarizes the Lacing procedures in accordance with one implementation:
Step 1: Obtain χₚ using forward fast motion estimation for all frames in GOP.
Step 2: Obtain χ_{b} using backward fast motion estimation for all frames in GOP.
Step 3: Using χₚ and χ_{b}, Lacing is performed for each macroblock in each picture frame to obtain the predicted motion vector into their corresponding reference frames.
Step 4: For each macroblock, refine the predicted motion vectors from Step 4 with another round of fast search in their corresponding reference frames.
Step 5: For each macroblock, choose either the forward or backward refined motion vector that gives minimum estimation error.

In various embodiments, an effect of the Lacing technique may be low computational complexity, which may depend on the type of fast ME method applied. From step 4 in the summarized Lacing procedures above, the number of search points per macroblock in the Lacing method can be 1.5 times² that of the corresponding fast ME techniques. This may be acceptable since fast ME methods have low average search points per macroblock to begin with.

Another source of extra computation comes from interpolating the motion vectors in eqn. (2), which attributed an additional 2×(12MULS+6ADDS) per macroblock on average.

This is a reasonably small overhead compared to N² ABS+(2N²−1)ADD operations required to calculate the SAD per macroblock at each search point.

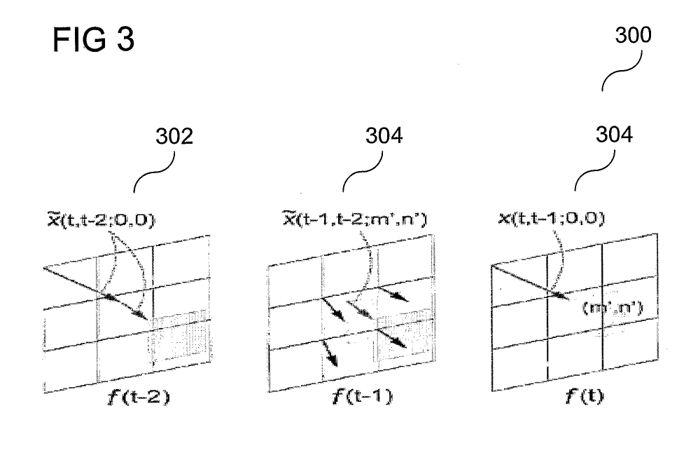

FIG. 3 shows a diagram 300 illustrating a motion trajectory of a macroblock across frames in accordance with an embodiment. In more detail FIG. 3 shows a plurality of e.g. three temporally immediately neighbouring frames 302, 304, 306, in which a linearly estimated motion vector is obtained that may reference the macroblock to any one of the frames 302, 304, 306. In this example, the motion vector

\tilde{x}(t,t−2;0,0)=x(t,t−1;0,0)+\tilde{x}(t−1,t−2;m′,n′) (17)

where \tilde{x}(t−1,t−2;m′,n′) is interpolated from the neighbouring motion vectors.

In various embodiments, one or more of the following GOPs (e.g. GOP 202) may be provided.

The set χₚ is an illustrating example for forward motion estimation that follows the {IPPP} frame coding pattern. This frame coding pattern is one of the simplest and commonly used in video coding (from the earliest standards like H.261 and MPEG-1, to the latest H.264).

Other representation is also possible, but it is of course limited to practicality.

In the alternate example where {X(1, 0), X(4, 1), X(5, 3) . . . X(K,K−n)}, some of the inter-frame distance is large, such as X(4, 1). This means the motion estimation may have to search a wider range to get accurate estimation. That is why the {IPPP . . . } pattern with unit inter-frame distance, i.e. {X(1, 0), X(2, 1), . . . , X(K,K−1)}, is still provided in many conventional video coding applications for speed and accuracy reasons. However, by restricting to unit inter-frame distance, the video application may be unable to utilize more advanced or more feature-enhanced frame coding patterns such as the hierarchical-B-picture (HB) structure and {IBBP} (as an alternative picture structure which may be provided in alternative embodiments) since these coding patterns may require interframe distance to be greater than a unit for motion estimation. That is, X(t₁,t₀) where t₁−t₀>1. Computation complexity (for motion estimation) may increase as t₁−t₀ becomes large because a large search area required to maintain the quality of estimation.

In scalable video coding in accordance with various embodiments, which use the hierarchical B-pictures structure, the ME representation may depend on the different temporal levels of hierarchy in the HB structure (such as e.g. HB structure 100). It is to be noted that other non-dyadic HB structures may also be used in alternative embodiments. It should further be noted that the Lacing algorithm is not restricted by whether the HB structure is dyadic or not.

In the following, some more details about various possible implementations of interpolation processes in accordance with various embodiments will be described.

Bilinear interpolation: Suppose the function f is known at four corners (0, 0), (1, 0), (0, 1) and (1, 1) of a unit square (e.g. a macroblock). For 0≦(x,y)≦1, the interpolated surface p is given by

$$p ( x , y ) = {\sum }_{i = 0}^{1} {\sum }_{j = 0}^{1} {a}_{ij} {x}^{i} {y}^{j} \qquad ( 18 )$$

where

a₀₀=f(0,0) (19)

a₁₀=f(1,0)−f(0,0) (20)

a₀₁=f(0,1)−f(0,0) (21)

a₁₁=f(0,0)−f(1,0)−f(0,1)−f(1,1) (22)

In this description, f may be replaced by the values of the motion vectors.

Bicubic interpolation: Suppose the function f is known at four corners (0, 0), (1, 0), (0, 1) and (1, 1) of a unit square (e.g. a macroblock). For 0≦(x,y)≦1, the interpolated surface p is given by

$$p ( x , y ) = {\sum }_{i = 0}^{3} {\sum }_{j = 0}^{3} {a}_{ij} {x}^{i} {y}^{j} \qquad ( 23 )$$

where the 16 coefficients aᵢⱼ are first obtained by solving a linear system constraint by values of f and its derivatives (fₓ,f_{y},f_{xy}) at the four corners.

In this description, f may be replaced by the values of the motion vectors.

In the following, some examples of Group of Pixels are illustrated which may be provided in various embodiments:

In video coding, a picture may usually be divided into blocks also referred to as macroblocks.

There are a few reasons for doing this, such as memory efficiency, localized analysis and processing, and coding efficiency.

Conventionally, the default macroblock size is 16×16. There is no particular mathematical reasoning for this choice and other choices may be provided in various embodiments. If the block is too big, local analysis may not be achieved. If the block is too small, say 1×1, it may lead to poor coding efficiency and render the analysis meaningless. So 16×16 size macroblocks may be a reasonable choice.

In various conventional video codecs, there are more varied choice of macroblock dimensions such as 16×8, 8×8, 4×4 etc. These blocks are called sub-blocks to differentiate them from the traditional coding approach of using 16×16 blocks, i.e. the macroblocks.

When describing the above embodiments, the word “macroblocks” may be used as a unit of data for measurement and processing. But it does not restrict the lacing algorithm to work on only 16×16 blocks. It is equally applicable to, for example, 8×8 or 16×8 and all other sub-blocks dimensions that are used in H.264/SVC.

Some more details on the lacing process will be provided below.

For a GOP of length K, we have

χ_{forward}^{IPP}={X1,0, X_{2,1}, . . . , X_{K,K-}1} (24)

and

χ_{backward}^{IPP}={X_{K-1,K}, X_{K-2,K-1}, . . . , X_{1,2}}, (25)

where X_{a,b} denotes the set of motion estimation result obtained by estimating f(a) from f(b).

In a GOP, e.g. of length K. Denote f as a picture frame. Therefore, f(1), f(2), . . . , f(K−1), f(K) are all in a GOP. Referring to FIG. 1, then K=8. Notice that f(0) 102 will be from a previous GOP, and not in the current GOP 120 that may consist of (or may include) f(1) to f(K); but f(0) is used to predict f(K) and f(K/2) (or f(8) and f(4) as in FIG. 1) to begin.

Merely for illustration purposes, let K=8. Looking at the first GOP of the HB structure 100 in FIG. 1, motion estimation information (observe the arrows between the frames to see the relations) may be obtained given by the following:

χ_{forward}^{HB}={X8,0,X_{4,0},X_{2,0},X_{6,4},X_{1,0},X_{3,2},X_{5,4},X_{7,6}} (26)

and

χ_{backward}^{HB}={X_{4,8},X_{2,4},X_{6,8},X_{1,2},X_{3,4},X_{5,6},X_{7,8}} (27)

As has been noted previously, it may be difficult to obtain the result X_{a,b} when |a−b|>>1, i.e., large temporal distance between f(a) and f(b). The usage of the HB structure in H.264/SVC may require to compute χ_{forward}^{HB} and χ_{backward}^{HB}, which nobody has been able to do it efficiently and accurately without using exhaustive methods. Fast ME methods may be unable to compute accurately X_{a,b}, where |a−b|>>1.

However, fast ME methods usually work nicely if |a−b|=1. Thus, in Lacing in accordance with various embodiments, the information χ_{forward}^{IPP} and χ_{backward}^{IPP} may first be computed which may be obtained confidently with fast ME methods. It should be noted that the embodiments are not restricted to fast ME methods, however, by way of example, any block-based ME method may be provided in alternative embodiments.

Lets restrict the following discussion to computing χ_{forward}^{HB} and χ_{forward}^{IPP}, since the procedures can be mirrored similarly for computing χ_{backward}^{HB} and χ_{backward}^{IPP}.

First, it is denoted X_{a,b}(x,y)∈ χ_{forward}^{HB} as the motion vector of macroblock located at (x,y) in frame f(a) estimated from frame f(b).

Similarly, it is denoted M_{a,a-1}(x,y)∈ χ_{forward}^{IPP} as the motion vector of macroblock located at (x,y) in frame f(a) estimated from frame f(a−1). For t₁>t₀, the approximation of Xₜ_{₁}_{,t}_{₀}(x,y) is given by \hat{X}ₜ_{₁}_{,t}_{₀}(x,y)∈ mₜ_{₁}_{,t}_{₀}^{t}^{₀}^{-t}^{₁}⁻¹ through computing the following iterative equations:

[x_{j,}yⱼ]=[xⱼ₋₁,yⱼ₋₁]+mₜ_{₁}_{,t}_{₀}^{j-1} (28)

$$\begin{matrix}[ {x}_{j}^{′} , {y}_{j}^{′} ] = [ N ⌊ \frac{{x}_{j}}{N} ⌋ , N ⌊ \frac{{y}_{j}}{N} ⌋ ] , & ( 29 ) \\ u = {b}_{l} ( \frac{{x}_{j} - {x}_{j}^{′}}{N} ) A ( {t}_{1} - j , {x}_{j}^{′} , {y}_{j}^{′} ) {b}_{r} ( \frac{{y}_{j} - {y}_{j}^{′}}{N} ) & ( 30 )\end{matrix}$$

mₜ_{₁}_{,t}_{₀}^{j}=mₜ_{₁}_{,t}_{₀}^{j-1}+u (31)

with the initial conditions

[x_{0,}y₀=[x,y] (32)

mₜ_{₁}_{,t}_{₀}⁰=Mₜ_{₁}^{,t}_{₁}₋₁(x_{0,}y₀) (33)

and

bₗ(q)=[1−q,q] (34)

bᵣ(q)=bₗ^{T}(q) [symbol] I₂ (35)

and

$$A ( t , x , y ) = [ \begin{matrix}{M}_{t , t - 1} ( x , y ) & {M}_{t , t - 1} ( x , y + N ) \\ {M}_{t , t - 1} ( x + N , y ) & {M}_{t , t - 1} ( x + N , y + N )\end{matrix} ] \qquad ( 36 )$$

The above equation to determine u is a bilinear interpolation of the motion vectors from neighboring macroblocks around the macroblock positioned at (xⱼ,yⱼ). It is possible to use other as such conventional interpolation techniques to obtain the motion vector, as discussed earlier. The above iterative equations are computing steps in a Lacing framework in accordance with various embodiments, which we outline in the following for motion estimating (forward and backward) frames ordered in the hierarchical B-pictures structure:

Algorithm 1: The Lacing Framework

Input: Motion estimation method Z
Input: GOP of length K
Compute X_{forward}^{IPP} using method Z;
Compute X_{backward}^{IPP} using method Z;
for t ← 1 to K do

L ← get the temporal level of frame f(t) in GOP;
D ← get the temporal distance of frame f(t) from its reference frame;
foreach Macroblock (x,y) in frame f(t) do

- Compute \hat{M}_{t,t-D}(x,y) using X_{forward}^{IPP} in eqn. (11)-(14);
- Compute \hat{M}_{t,t+D}(x,y) using X_{backward}^{IPP} in eqn. (11)-(14);
- Compute \hat{M}′_{t,t-D}(x,y) and \hat{M}′_{t,t+D}(x,y) which are refinements
of \hat{M}_{t,t-D}(x,y) and \hat{M}_{t,t+D}(x,y) respectively by another around
of ME using method Z;
- Based on minimum error critera (such as the Sum- of-
Absolute-Difference), decide the which motion estimation
result to be used by the macroblock: forward
\hat{M}′_{t,t-D}(x,y) or backward \hat{M}′_{t,t+D}(x,y);

end

end

Motion estimation is usually performed in spatial picture domain (block based) unless otherwise specified, such as “Motion estimation via Phase Correlation” or “Motion Estimation in FFT domain”. Motion estimation may be understood as a process of obtaining motion information between two or more pictures frames. That information is also referred to as a motion vector.

For Lacing, it uses the motion information (computed by motion estimation method, say, XYZ) to predict motion vectors, that could not be computed otherwise by method XYZ. That is, given a set of motion vectors M, Lacing can use the information in set M to predict motion vectors that could not be computed by the same method that gives the set M.

In summary, the lacing can be described by the following (which is a plain english explanation of the above iteration equations and Algorithm 1):

A method of estimating motion vectors for a block-based video compression scheme including:

i) a current frame, a reference frame and a set of intermediate frames between the current frame and reference frame;

ii) a set of motion vectors (which will be described in more detail below);

iii) predicting the motion vector of the current frame and the reference frame from the set of motion vectors.

Item (i) states the settings in which various embodiments apply. Assume a current frame for which should be obtained its motion estimation from a reference frame. However there are one or more frames (the intermediate frames) that are between the current frame and reference frame, according to their temporal display order (either incremental or decremental in time). This motion estimation scenario applies to several coding structures such as IBBP, IBPBP, and Hierarchical-B pictures.

Item (ii) states the data required to compute the predicted motion vector in item (iii). This data is the set X of motion vectors is described by:

t₀ ← index of reference frame;
t₁ ← index of current frame;
X = ;
for t ← t₀ + 1 to t₁ do

- X_{t,t-1} ← Compute motion estimation of current frame f(t) from
reference frame f(t − 1);
- add X_{t,t-1} to set X

end
Note: the intermediate frames are f(t) where (t₀ < t < t₁) or
(t₁ < t < t₀).

Item (iii) describes an idea of various embodiments. Using item (ii) to predict motion vector in the setting describe by item (i). The steps of item (iii) is describe as follows:

Input: f(t₁), current frame
Input: f(t₀), reference frame
Input: X_{forward}^{IPP}, set of motion vector if t₁ > t₀. (see eqn (7))
Input: X_{backward}^{IPP}, set of motion vector if t₁ < t₀. (see eqn (8))
foreach Macroblock (x,y) in frame f(t₁) do

(pₓ,p_{y}) ← (x,y);
for t ← t₁ to t₀ + 1 do

if (pₓ,p_{y}) is a valid macroblock position in f(t) then

- (mₓ,m_{y}) ← get motion vector of macroblock
(pₓ,p_{y}) from
X_{t,t-1};

else

- Denote B as the macroblock in f(t) that contains the
position (pₓ,p_{y});
- (mₓ,m_{y}) ← interpolate the motion vectors of
macroblock B,
macroblock right of B, macroblock bottom of B and
macroblock right-bottom of B from X_{t,t}_1;

end
/* update (pₓ,p_{y}) with the copied/interpolated motion

| | |
|---|---|
| vector (mₓ,m_{y}) | */ |

(pₓ,p_{y}) ← (pₓ,p_{y}) + (mₓ,m_{y});

end
- The predicted motion vector of Macroblock (x,y) of f(t₁) with
reference frame f(t₀) is given by (pₓ − x,p_{y} − y);
- Refine the motion vector (pₓ − x,p_{y} − y) to get minimum
estimation error;
- The refined motion vector assign to this macroblock (x,y) as
final result;

end

In various embodiments, a method for estimating motion in a plurality of frames is provided, the method including determining a first set of motion vectors with respect to a first frame and a second frame, the second frame being in succession with the first frame along a time direction, determining a second set of motion vectors with respect to a predicted frame and the second frame, the predicted frame being in succession with the first frame along the time direction; wherein some motion vectors of the second set of motion vectors are interpolated from motion vectors of the first set of motion vectors; and determining a third set of motion vectors based on the first set of motion vectors and the second set of motion vectors.

In an implementation of this embodiment, the second set of motion vectors may be determined with respect to the predicted frame and the second frame, wherein the predicted frame and the second frame are separated from the first frame by the same temporal distance, along the time direction. Illustratively, the predicted frame may be at the same temporal location as the second frame along the time direction. In another implementation of this embodiment, one or more predicted frames may be selected or chosen from any temporal location along the time direction across the plurality of frames, and motion vectors associated to these predicted frames may be determined along the time direction with reference to any first frame along the time direction in the plurality of frames. In yet another implementation of this embodiment, the first set of motion vectors may be determined with respect to a group of pixels in the first frame and a group of pixels in the second frame to provide a set of motion vectors associated with the groups of pixels in the second frame. In yet another implementation of this embodiment, each motion vector in the second set of motion vectors may be determined with respect to a group of pixels in the predicted frame and the group of pixels in the second frame to provide a motion vector associated with the group of pixels in the predicted frame. In yet another implementation of this embodiment, the motion vector associated with the group of pixels in the predicted frame may be interpolated from the motion vectors associated with the groups of pixels in the second frame, wherein the groups of pixels in the second frame is adjacent to the group of pixels in the predicted frame. In yet another implementation of this embodiment, the motion vector associated with the group of pixels in the predicted frame may be interpolated from the motion vectors associated with the groups of pixels in the second frame, the groups of pixels in the second frame having pixels overlapping the group of pixels in the predicted frame. In yet another implementation of this embodiment, as such, the third set of motion vectors may include motion vectors associated with the groups of pixels in the predicted frames. In yet another implementation of this embodiment, the motion vector associated with the group of pixels in the predicted frame may be determined by interpolating the motion vectors associated with the groups of pixels in the second frame being adjacent to the position of the group of pixels in the predicted frame, wherein the position of the group of pixels in the predicted frame may be determined with respect to the group of pixels in the predicted frame and the group of pixels in the first frame. In yet another implementation of this embodiment, illustratively, the position of the group of pixels in the predicted frame may be estimated from position of the group of pixels in the first frame. The position of the group of pixels in the predicted frame may be in the region surrounded by groups of pixels in the second frame, wherein two or more groups of pixels in the second frame being adjacent or overlapping the position of the group of pixels in the predicted frame. The motion vector associated with these two or more groups of pixels in the second frame may then be interpolated to provide the motion vector associated to the group of pixels in the predicted frame at the position. As such, the third set of motion vectors may include interpolated motion vectors associated with the groups of pixels in the second frame. In yet another implementation of this embodiment, the motion vector associated with the group of pixels in the predicted frame may be the motion vector associated with the group of pixels in the second frame, wherein the group of pixels in the predicted frame may be at the same position as the group of pixels in the second frame. In yet another implementation of this embodiment, illustratively, the group of pixels in the predicted frame matches the position of the group of pixels in the second frame. As such, interpolation may not be required and the motion vector of the group of pixels in the predicted frame may be updated with the motion vector associated with the group of pixels in the second frame. In yet another implementation of this embodiment, the method for estimating motion in a plurality of frames may further include determining a fourth set of motion vectors with respect to the first frame and the second frame, the second frame being in succession with the first frame along another time direction being opposite to the time direction. In yet another implementation of this embodiment, the method may further include determining a fifth set of motion vectors with respect to the predicted frame and the second frame, the predicted frame being in succession with the first frame along another time direction being opposite of the time direction; wherein motion vectors of the fifth set of motion vectors are interpolated from motion vectors of the fourth set of motion vectors. In yet another implementation of this embodiment, illustratively, the predicted frame and the second frame may be separated from the first frame by the same temporal distance, along another time direction. The predicted frame may be at the same temporal location as the second frame along the time direction. In yet another implementation of this embodiment, illustratively, one or more predicted frames may be selected or chosen from any temporal location along the another time direction across the plurality of frames, and motion vectors associated to these predicted frames may be determined along the time direction with reference to any first frame along the another time direction in the plurality of frames. In yet another implementation of this embodiment, illustratively, the direction of determining the motion vectors of the fourth set of motion vectors and of the fifth set of motion vectors may be opposite to the direction of determining the motion vectors of the first set of motion vectors and of the second set of motion vectors. The motion vectors of the fourth set of motion vectors and of the fifth set of motion vectors may be backward motion vectors, whereas the motion vectors of the first set of motion vectors and of the second set of motion vectors may be forward motion vectors. The implementations of determining the first set of motion vectors and the second set of motion vectors can be applied to the fourth set of motion vectors and the fifth set of motion vectors at the group of pixels level. In yet another implementation of this embodiment, the method may further include determining an estimation error of each motion vector of the second set of motion vectors, and an estimation error of each motion vector of the fifth set of motion vectors. In yet another implementation of this embodiment, illustratively, for the second set of motion vectors and the fifth set of motion vectors, the estimation error may be computed using a minimum possible residual energy determined between the group of pixels in the predicted frame and the group of pixels in the second frame. In yet another implementation of this embodiment, the estimation error may be computed using the sum of absolute difference (SAD). In yet another implementation of this embodiment, the estimation error of each motion vector of the second set of motion vectors may be compared against the estimation error of each motion vector of the fifth set of motion vectors, to provide comparison results. In yet another implementation of this embodiment, the third set of motion vectors may then be determined depending on the comparison results. In yet another implementation of this embodiment, the third set of motion vectors may include motion vectors of the fourth set of motion vectors and motion vectors of the fifth set of motion vectors if the estimation errors of the motion vectors of the fifth set of motion vectors are lower than the estimation errors of the motion vectors of the second set of motion vectors. In yet another implementation of this embodiment, illustratively, if the estimation error of the motion vector of the fifth set of motion vectors is lower than the estimation error of the motion vector of the second set of motion vectors, the motion vector of the fifth set of motion vectors may be selected and may be included in the third set of motion vectors. The motion vector of the second set of motion vectors may be retained or selected if otherwise. In yet another implementation of this embodiment, the groups of pixels in the first frame, the groups of pixels in the second frame, and the group of pixels in the predicted frame may have the same number of pixels. In yet another implementation of this embodiment, the group of pixels may be a square block of pixels, a rectangular block of pixels, or a polygonal block of pixels. In yet another implementation of this embodiment, each group of pixels may be a macroblock, the macroblock size may be selected from 16 pixels by 16 pixels, 16 pixels by 8 pixels, 8 pixels by 8 pixels, 8 pixels by 16 pixels, 8 pixels by 4 pixels, 4 pixels by 8 pixels, and 4 pixels by 4 pixels. In yet another implementation of this embodiment, the temporal distance between the first frame and the second frame may be less than or equal to three frames. In yet another implementation of this embodiment, the temporal distance between the first frame and the second frame may be exactly one frame. In yet another implementation of this embodiment, the temporal distance between the first frame and the predicted frame may be between 1 and K−1, where K being the number of frames in the plurality of frames. In yet another implementation of this embodiment, the first frame may be the reference frame. The second frame may be the intermediate frame. The predicted frame may be the current or target frame. In yet another implementation of this embodiment, the third set of motion vectors may include a series of motion vectors that represent the motion information obtained iteratively between the predicted frames or current frames and a first frame or reference frame. The third set of motion vectors may further represent the motion trajectory from one frame in the plurality of frames, to the target or current frame, across the plurality of frames, the plurality of frames being a group of picture (GOP) including three or more frames. In yet another implementation of this embodiment, the first set of motion vectors and the fourth set of motion vectors may be determined using a fast search algorithm. The fast search algorithm may be selected from but not limited to three-step search, two-dimensional logarithmic search, diamond search, and adaptive rood pattern search. In yet another implementation of this embodiment, the plurality of frames may be associated with a group of pictures coded according to an Advanced Video coding structure. In yet another implementation of this embodiment, the plurality of frames may be associated with a group of pictures coded according to a Scalable Video coding structure. In yet another implementation of this embodiment, the plurality of frames may be associated with a group of pictures encoded according to a Hierarchical B-picture prediction structure, wherein motion estimation across the GOP may be determined in accordance with the direction and coding order of the Hierarchical B-picture prediction structure. In yet another implementation of this embodiment, the method may be referred to as lacing with a possible effect to improve the prediction accuracy of fast motion estimation in the Hierarchical B-picture prediction structure. In yet another implementation of this embodiment, the group of pixels in each frame may be transformed using a domain transform to provide a set of domain transformed coefficients for each frame. The domain transform may be a domain transform such as e.g. type-I DCT, type-IV DCT, type-I DST, type-IV DST, type-I DFT, type-IV and DFT. In yet another implementation of this embodiment, the domain transform may be a linear transform such as e.g. karhunen loeve transform, hotelling transform, fast fourier transform (FFT), short-time fourier transform, discrete wavelet transform (DWT), and dual tree wavelet transform (DT-WT).

In another embodiment, a device for estimating motion in a plurality of frames is provided. The device may include a first circuit configured to determine a first set of motion vectors with respect to a first frame and a second frame, the second frame being in succession with the first frame along a time direction, a second circuit configured to determine a second set of motion vectors with respect to a predicted frame and the second frame, the predicted frame being in succession with the first frame along the time direction; wherein some motion vectors of the second set of motion vectors are interpolated from motion vectors of the first set of motion vectors; and a third circuit configured to determine a third set of motion vectors based on the first set of motion vectors and the second set of motion vectors.

In an implementation of this embodiment, the device may include an interpolating circuit configured to interpolate the motion vector associated with the group of pixels in the predicted frame from the motion vectors associated with the groups of pixels in the second frame, the groups of pixels in the second frame being adjacent to the group of pixels in the predicted frame. The interpolating circuit being configured to interpolate the motion vector associated with the group of pixels in the predicted frame from the motion vectors associated with the groups of pixels in the second frame, the groups of pixels in the second frame having pixels overlapping the group of pixels in the predicted frame. In another implementation of this embodiment, the device may include a fourth circuit configured to determine a fourth set of motion vectors with respect to the first frame and the second frame, the second frame being in succession with the first frame along another time direction being opposite to the time direction. In yet another implementation of this embodiment, in addition, a fifth circuit configured to determine a fifth set of motion vectors with respect to the predicted frame and the second frame, the predicted frame being in succession with the first frame along another time direction being opposite of the time direction; wherein motion vectors of the fifth set of motion vectors are interpolated from motion vectors of the fourth set of motion vectors. In yet another implementation of this embodiment, the device may further include an estimation error circuit configured to determine an estimation error of each motion vector of the second set of motion vectors, and an estimation error of each motion vector of the fifth set of motion vectors. In yet another implementation of this embodiment, the device may further include a comparator circuit configured to compare the estimation error of each motion vector of the second set of motion vectors against the estimation error of each motion vector of the fifth set of motion vectors, wherein the third set of motion vectors may be determined depending on the comparison results.

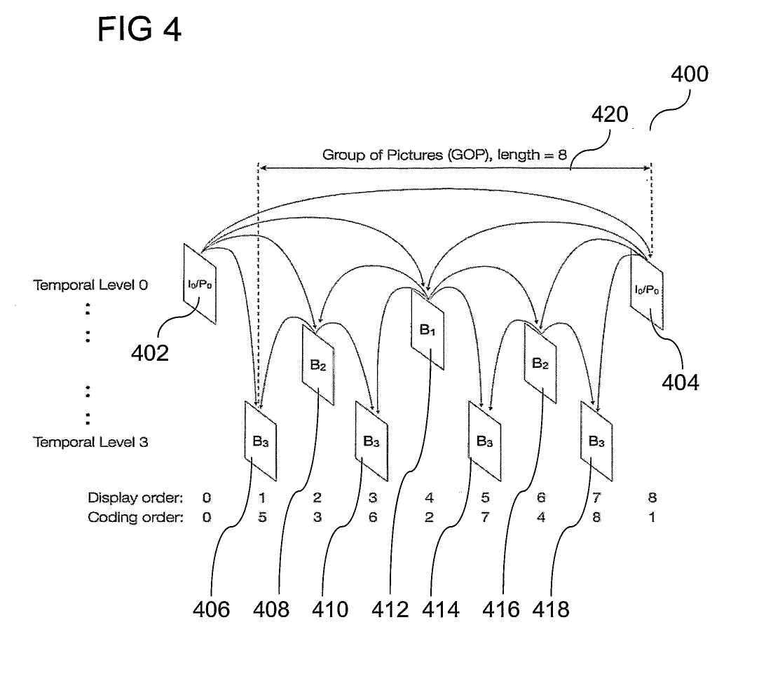

FIG. 4 shows a hierarchical B structure of another embodiment. Frames 404,406, 408, 410, 412, 414, 416, 418 (e.g. so-called P and B-pictures) at the higher temporal levels of the hierarchical B-picture (HB) structure 400 are motion estimated from reference frames 402, 404 (e.g. so-called I-pictures, P-pictures or B-pictures) that are at the lower temporal levels and temporally further apart. In this implementation, the HB structure 400 may include a plurality of e.g. three temporal levels.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for estimating motion in a plurality of frames, the method comprising:
determining a first set of motion vectors with respect to a first frame and a second frame, the second frame being in succession with the first frame along a time direction;
determining a second set of motion vectors with respect to a predicted frame and the second frame, the predicted frame being in succession with the first frame along the time direction; wherein one or more motion vectors of the second set of motion vectors are interpolated from one or more motion vectors of the first set of motion vectors; and
determining a third set of motion vectors based on the first set of motion vectors and the second set of motion vectors.

2. The method according to claim 1,
wherein each motion vector in the first set of motion vectors is determined with respect to a first group of pixels in the first frame and a second group of pixels in the second frame to provide a motion vector associated with the second group of pixels in the second frame.

3. The method according to claim 1,
wherein each motion vector in the second set of motion vectors is determined with respect to a predicted group of pixels in the predicted frame and a second group of pixels in the second frame to provide a motion vector associated with the predicted group of pixels in the predicted frame.

4. The method according to claim 3,
wherein the motion vector associated with the predicted group of pixels in the predicted frame is interpolated from motion vectors associated with the second group of pixels in the second frame, the second group of pixels in the second frame being adjacent to the predicted group of pixels in the predicted frame.

5. The method according to claim 3,
wherein the motion vector associated with the predicted group of pixels in the predicted frame is interpolated from motion vectors associated with the second group of pixels in the second frame, the second group of pixels in the second frame having pixels overlapping the predicted group of pixels in the predicted frame.

6. The method according to claim 1, further comprising:
determining a fourth set of motion vectors with respect to the first frame and the second frame, the second frame being in succession with the first frame along another time direction being opposite to the time direction,

7. The method according claim 1, further comprising:
determining a fifth set of motion vectors with respect to the predicted frame and the second frame, the predicted frame being in succession with the first frame along another time direction being opposite of the time direction; wherein motion vectors of the fifth set of motion vectors are interpolated from motion vectors of the fourth set of motion vectors.

8. The method according to claim 7, further comprising:
determining a second estimation error of each motion vector of the second set of motion vectors, and a fifth estimation error of each motion vector of the fifth set of motion vectors.

9. The method according to claim 8, further comprising:
comparing the second estimation error of each motion vector of the second set of motion vectors against the fifth estimation error of each motion vector of the fifth set of motion vectors, wherein the third set of motion vectors is determined depending on results of the comparing.

10. The method according to claim 8,
wherein the third set of motion vectors further comprising one or more motion vectors of the fourth set of motion vectors and one or more motion vectors of the fifth set of motion vectors, wherein the fifth estimation errors of the motion vectors of the fifth set of motion vectors are lower than the second estimation errors of the motion vectors of the second set of motion vectors.

11. The method according to claim 1 further comprising transforming at least one group of pixels of the first frame, the second frame and the predicted frame, the transforming including using a domain transform to provide a set of domain transformed coefficients for each of the first frame, the second frame and the predicted frame.

12. The method according to claim 11,
wherein the domain transform is at least one of type-I DCT, type-IV DCT, type-I DST, type-IV DST, type-I DFT, and type-IV DFT.

13. The method according to claim 1,
wherein the plurality of frames is a group of pictures in an advanced video coding structure.

14. The method according to claim 1,
wherein the plurality of frames is a group of pictures in a scalable video coding structure.

15. A device for estimating motion in a plurality of frames, the device comprising:
one or more circuits configured to:
determine a first set of motion vectors with respect to a first frame and a second frame, the second frame being in succession with the first frame along a time direction;
determine a second set of motion vectors with respect to a predicted frame and the second frame, the predicted frame being in succession with the first frame along the time direction; wherein one or more motion vectors of the second set of motion vectors are interpolated from one or more motion vectors of the first set of motion vectors; and
determine a third set of motion vectors based on the first set of motion vectors and the second set of motion vectors.

16. The device according to claim 15,
wherein each motion vector in the first set of motion vectors is determined with respect to a first group of pixels in the first frame and a second group of pixels in the second frame to provide a motion vector associated with the second group of pixels in the second frame.

17. The device according claim 15,
wherein each motion vector in the second set of motion vectors is determined with respect to a predicted group of pixels in the predicted frame and a second group of pixels in the second frame to provide a motion vector associated with the predicted group of pixels in the predicted frame.

18. The device according to claim 17, wherein the one or more circuits are configured to:
interpolate the motion vector associated with the group of pixels in the predicted frame from motion vectors associated with the second group of pixels in the second frame, the second group of pixels in the second frame being adjacent to the predicted group of pixels in the predicted frame.

19. The device according to claim 17,
wherein the one or more circuits are configured to interpolate the motion vector associated with the predicted group of pixels in the predicted frame from the motion vectors associated with the second group of pixels in the second frame, the second group of pixels in the second frame having pixels overlapping the predicted group of pixels in the predicted frame.

20. The device according to claim 15, wherein:
the one or more circuits are configured to determine a fourth set of motion vectors with respect to the first frame and the second frame, the second frame being in succession with the first frame along another time direction being opposite to the time direction.

21. The device according to claim 15, wherein:
the one or more circuits are configured to determine a fifth set of motion vectors with respect to the predicted frame and the second frame, the predicted frame being in succession with the first frame along another time direction being opposite of the time direction; wherein motion vectors of the fifth set of motion vectors are interpolated from motion vectors of the fourth set of motion vectors.

22. The device according to claim 21, wherein:
the one or more circuits are configured to determine second estimation error of each motion vector of the second set of motion vectors, and a fifth estimation error of each motion vector of the fifth set of motion vectors.

23. The device according to claim 22, wherein:
the one or more circuits are configured to compare the second estimation error of each motion vector of the second set of motion vectors against the fifth estimation error of each motion vector of the fifth set of motion vectors, wherein the third set of motion vectors is determined depending on results of the comparison.

24. The device according to claim 22,
wherein the third set of motion vectors further comprises one or more motion vectors of the fourth set of motion vectors and one or more motion vectors of the fifth set of motion vectors, wherein the fifth estimation errors of the motion vectors of the fifth set of motion vectors are lower than the second estimation errors of the motion vectors of the second set of motion vectors.

25. The device according to claim 15, wherein:
the one or more circuits are configured to transform at least one group of pixels of the first frame, the second frame and the predicted frame using a domain transform to provide a set of domain transformed coefficients for each of the first frame, the second frame and the predicted frame.

26. The device according to claim 25,
wherein the one or more circuits includes a domain transform circuit configured to provide a domain transform selected from a group of domain transforms consisting of type-I DCT, type-IV DCT, type-I DST, type-IV DST, type-I DFT, and type-IV DFT.

27. The device according to claim 15,
wherein the plurality of frames is a group of pictures in an advanced video coding structure.

28. The device according to claim 15,
wherein the plurality of frames is a group of pictures in a scalable video coding structure.
